(19) United States
(12) Patent Application Publication
(10) Pub. No.: US 2026/0160127 A1
(43) Pub. Date: Jun. 11, 2026

(54) DRILL-FREE INSTALLATION MECHANISM AND SYSTEM

(71) Applicant: HANGZHOU GIPUTA CLOTHING CO., LTD., Hangzhou (CN)

(72) Inventors: Yu Pan, Hangzhou (CN); Michael Alexander Mayer, Hangzhou (CN)

(73) Assignee: HANGZHOU GIPUTA CLOTHING CO., LTD., Hangzhou (CN)

(21) Appl. No.: 19/247,335

(22) Filed: Jun. 24, 2025

(30) Foreign Application Priority Data
Jul. 5, 2024 (CN) 2024215812326
Aug. 22, 2024 (CN) 202422041494X

(51) Int. Cl. E06B 9/42

(52) U.S. Cl. CPC E06B 9/42

(57) ABSTRACT

A drill-free installation mechanism and system, including a support base configured to connect with an external structure; a support block slidably connected to the support base; an anti-slip structure disposed on the support block; and a status adjusting element movably connected to the support block. When a force is applied, the status adjusting element drives relative movement between the support block and the support base, and constrains the connection posture between them. The invention enables expansion against a support surface, allowing a device using the mechanism to be stably positioned within a window frame or door frame. This mechanism offers enhanced convenience in use, stable engagement between components, and reduced likelihood of separation, thereby improving operational ease and user experience.

### FILED OF THE INVENTION

The invention relates to a installation mechanism, and more particularly to drill-free installation mechanism and system.

### BACKGROUND OF THE INVENTION

The mounting structure is used in locations such as homes and offices—specifically for items like curtains or barrier panels that are in contact with walls. It serves to establish a fixed connection with the wall. Taking curtains as an example: when installing curtains, commonly used mounting structures include mounting brackets and screws. However, screw installation leaves screw holes on the window frame. If the curtains need to be reinstalled or replaced, new holes must be drilled, making it impossible to reuse the original position. This inevitably leaves multiple screw holes on the wall, which not only damages the wall but also affects its appearance. Additionally, drilling creates dust, making cleanup inconvenient and the installation process time-consuming and labor-intensive. Although there are many no-drill curtain mounting solutions available on the market today, most existing no-drill mounting components have complex structures and delicate parts that are prone to damage, making them inconvenient to use.

### SUMMARY OF THE INVENTION

The present invention is directed to providing drill-free installation mechanism and system, aiming to solve the technical problem of inconvenience in use associated with existing roller blinds.

To achieve the foregoing objective, the present invention adopts the following technical solution:

Drill-free installation mechanism comprising:
a support base configured to connect with an external structure;
a support block slidably connected to the support base;
an anti-slip structure arranged on the support block;
a status adjusting element movably connected to the support block, wherein when subjected to an acting force, the status adjusting element drives the support block to move relative to the support base and limits the connection posture between the support block and the support base.

Further, the support base is provided with a positioning groove for limiting the relative movement direction between the support block and the support base; the support block is provided with a sliding block adapted to the positioning groove.

Further, a first plate, one end of which is provided with the positioning groove;
a second plate arranged at an angle to the first plate, the second plate being provided with a slotted hole for positioning the status adjusting element.

Further, the support block comprises:
a support block body provided with the sliding block;
a connecting rod connected to the support block body, one end of the connecting rod passing through the second plate as a connection end; the connection end being connected to the status adjusting element.

Further, one end face of the support block body is fixedly connected to the connecting rod; the other end face is provided with a receiving groove adapted to the anti-slip structure.

Further, the connecting rod is connected to the status adjusting element by one or more of threaded connection, snap connection, or plug connection.

Further, the first plate is provided with a connection portion configured to connect with an external structure.

A system, characterized in that it comprises a drill-free installation mechanism as described above.

The beneficial effects of the drill-free installation mechanism and system provided by the present invention are as follows:
Compared with the prior art, the drill-free installation mechanism contacts and expands tightly against the supporting surface, enabling the device using this mechanism to be supported within a window frame or door frame. It features a simplified structure, ease of use, stable fit between components, and resistance to separation, thereby enhancing the convenience of the device during use.

### BRIEF DESCRIPTION OF THE DRAWINGS

By reading the detailed description provided with reference to the drawings of non-limiting embodiment, other features, objectives, and advantages of the invention will become more apparent:

FIG. 1 is a schematic structural diagram of a system using drill-free installation mechanism according to an embodiment of the present invention;

FIG. 2 is an exploded view of a system using drill-free installation mechanism according to an embodiment of the present invention;

FIG. 3 is a schematic structural diagram of the drill-free installation mechanism according to an embodiment of the present invention;

FIG. 4 is a first schematic structural diagram of the support base used in FIG. 3;

FIG. 5 is a second schematic structural diagram of the support base used in FIG. 3;

FIG. 6 is a schematic structural diagram of the support block used in FIG. 3;

FIG. 7 is a schematic structural diagram of the locking nut used in FIG. 3;

FIG. 8 is a schematic structural diagram of the fixing assembly used in a drill-free installation mechanism according to an embodiment of the present invention;

FIG. 9 is a schematic diagram of the usage state of the fixing assembly used in a drill-free installation mechanism according to an embodiment of the present invention;

FIG. 10 is a schematic structural diagram of another fixing assembly used in a drill-free installation mechanism according to an embodiment of the present invention;

FIG. 11 is a schematic structural diagram of yet another fixing assembly used in a drill-free installation mechanism according to an embodiment of the present invention.

Description of reference numerals:
1—Curtain Fabric;
2—Beam Assembly;
3—drill-free installation mechanism;
31—Support Base;
311—Positioning Groove;
312—Circular Hole;
313—Slotted Hole;
314—Connection Portion;
32—Support Block;
321—Sliding Block;
322—Receiving Groove;
323—Connecting Rod;
33—Anti-slip Structure;
34—Status Adjusting Element;
4—Fixing Assembly;
41—Deformable Member;
411—First Deformable Body;
412—Second Deformable Body;
42—Fixing Member.

### DETAILED DESCRIPTION OF THE PREFERRED EMBODIMENTS

In order to make the technical problems to be solved, the technical solutions, and the beneficial effects of the present invention more clear and understandable, the present invention is further described in detail below with reference to the accompanying drawings and embodiments. It should be understood that the specific embodiments described herein are merely intended to illustrate the present invention and are not intended to limit its scope.

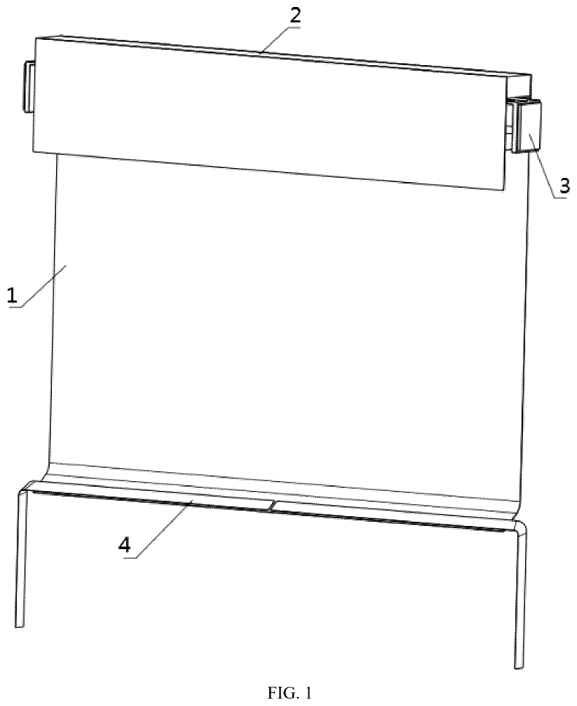

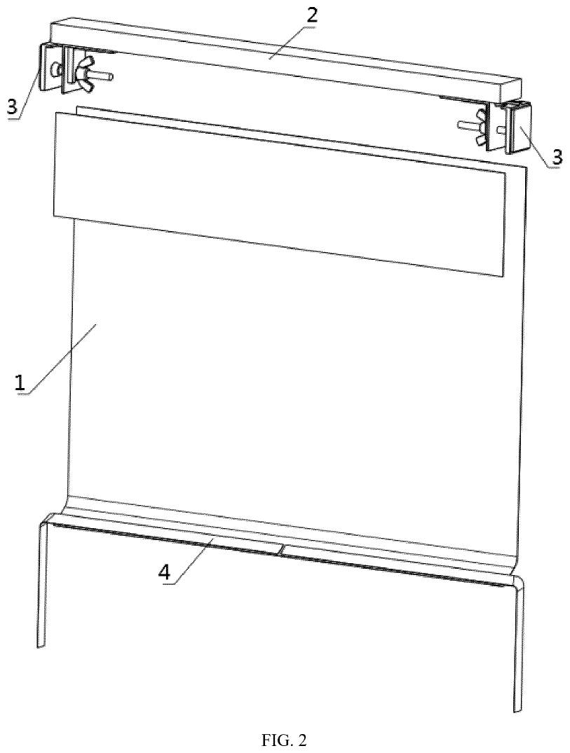

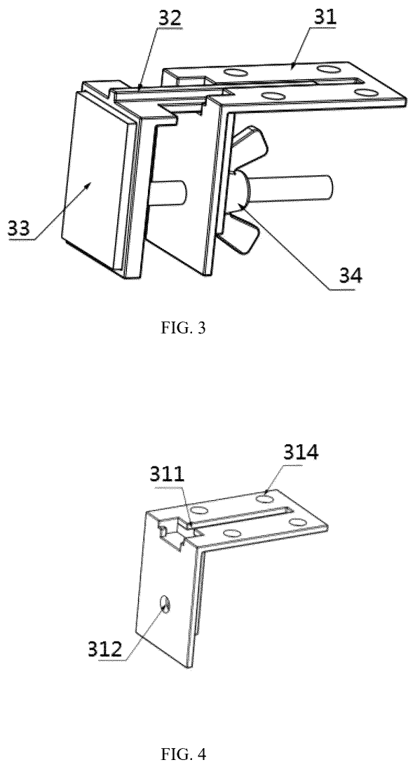

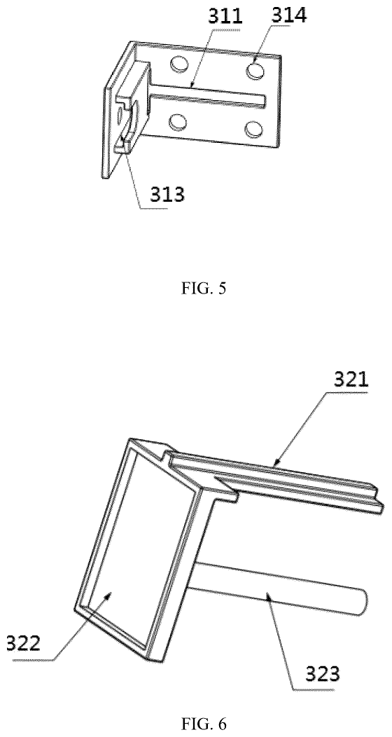

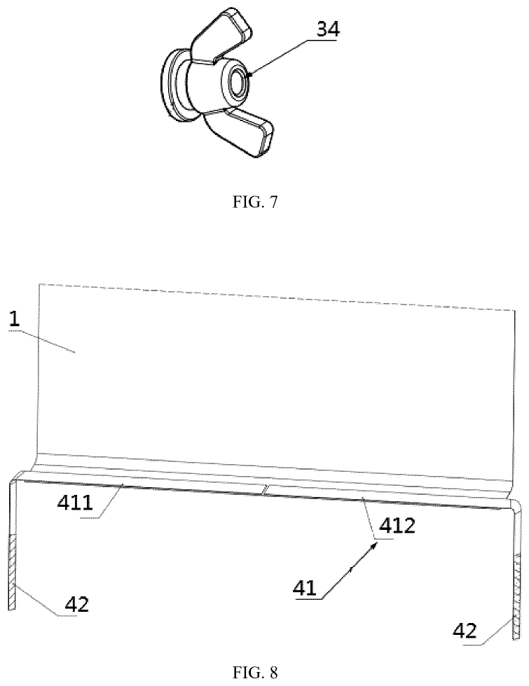

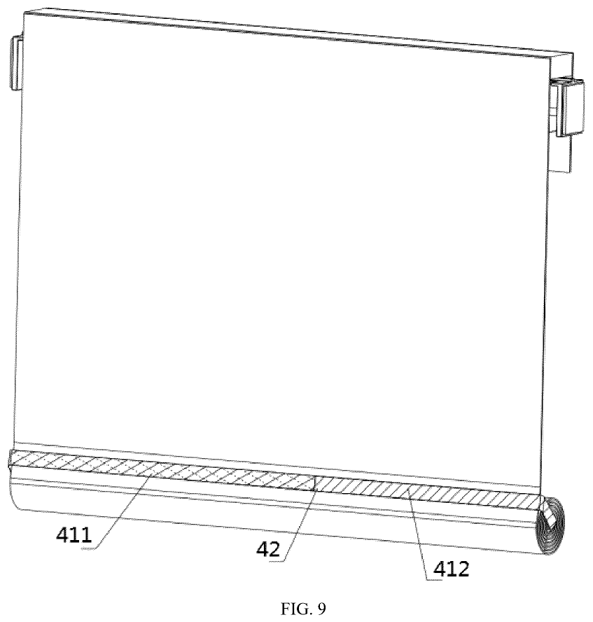

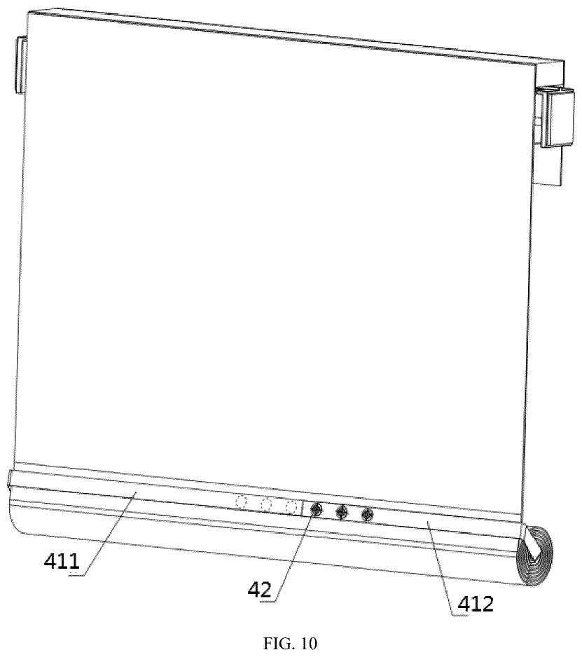

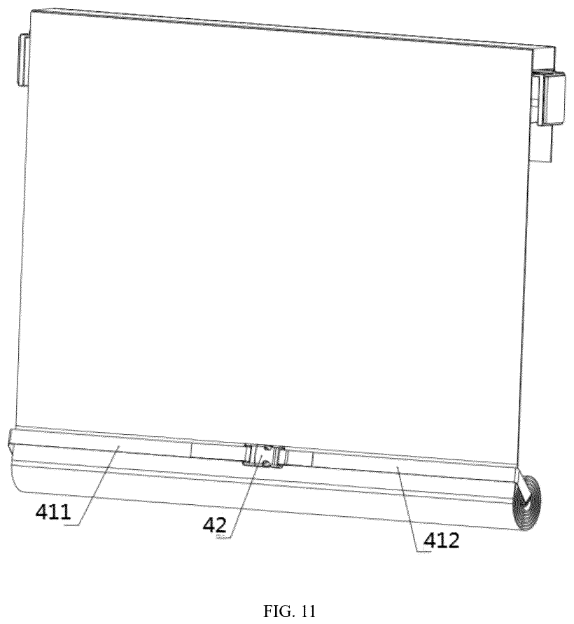

Please refer to FIGS. 1 to 11. An invention providing a drill-free installation mechanism is described as follows. The drill-free installation mechanism includes a support base 31, a support block 32, an anti-slip structure 33, and a status adjusting element 34. The support base 31 is used for connection with an external structure. The support block 32 is slidably connected to the support base 31. The anti-slip structure 33 is disposed on the support block 32. The status adjusting element 34 is movably connected to the support block 32. When a force is applied, the status adjusting element 34 drives the support block 32 to move relative to the support base 31 and limits the connection posture between the support block 32 and the support base 31.

In one specific embodiment of the present invention, the support base 31 is provided with a positioning groove 311 that defines the relative motion direction between the support block 32 and the support base 31. The support block 32 is provided with a sliding block 321 adapted to the positioning groove 311.

In another specific embodiment of the present invention, the support base 31 includes a first plate and a second plate. One end of the first plate is provided with the positioning groove 311; the second plate is arranged at an angle relative to the first plate and is provided with a slotted hole 313 for positioning the status adjusting element 34.

In this embodiment, the first plate is provided with a connection portion 314 for connecting with the external structure. The connection portion 314 is detachably connected to the external structure.

In one specific embodiment of the present invention, the support block 32 includes a support block body and a connecting rod 323. The support block body is provided with a sliding block 321. The connecting rod 323 is connected to the support block body, and one end of the connecting rod 323 passes through the second plate and serves as a connection end. The connection end is connected to the status adjusting element 34.

In this embodiment, one end face of the support block body is fixedly connected to the connecting rod 323, and the other end face is provided with a receiving groove 322 adapted to the anti-slip structure 33.

In this embodiment, the connecting rod 323 and the status adjusting element 34 are connected by one or more of the following: threaded connection, snap-fit, or insertion.

Operation Process: A positioning groove 311 is provided on the end face of the first plate of the support base 31. The positioning groove 311 cooperates with the positioning rib (i.e., the sliding block 321) on the support block 32, allowing the support block 32 to slide horizontally relative to the support base 31. A circular hole 312 is formed on the second plate of the support base 31, allowing the connecting rod 323 on the support block 32 to pass through. Specifically, the connecting rod 323 may be a threaded rod. A slotted hole 313 is provided on the inner side of the second plate to position the status adjusting element 34, so that the status adjusting element 34 cannot move horizontally relative to the support base 31. The overall shape of the support block 32 is L-shaped, which is used to adjust the distance from the supporting surface and to exert an expansion-tightening effect. The lateral end face of the support block 32 is provided with a positioning rib (i.e., the sliding block 321), which cooperates with the positioning groove 311 to enable the support block 32 to move horizontally along the positioning groove 311. The outer side of the support block body is provided with a receiving groove 322 for accommodating the anti-slip structure 33. The inner side of the support block body is provided with a threaded rod, namely the connecting rod 323, which passes through the circular hole 312 on the support base 31 and cooperates with a locking nut (i.e., the status adjusting element 34). Under the driving force of the locking nut (i.e., the status adjusting element 34), the support block 32 can move relative to the support base 31. The tightening nut (i.e., the status adjusting element 34) is located on the support base 31, with a circular ring at the bottom, which is mounted and positioned within the slotted hole. It allows adjustment of the support block 32 relative to the support base 31, adjusting the distance between the support block 32 and the supporting surface so that the support block 32 can press tightly against or release from the supporting surface. The tightening nut is a wing nut. The anti-slip structure 33 is mounted in the receiving groove 322 of the support block body and contacts the supporting surface to prevent the drill-free installation mechanism from slipping after being expanded and fixed in place. The anti-slip structure 33 is a silicone pad.

Compared with the prior art, the drill-free installation mechanism provided by the present invention allows the drill-free installation mechanism 3 to be pressed tightly against the supporting surface, thereby enabling a system using this mechanism to be supported within a window frame or door frame. It features a simplified structure, ease of use, stable cooperation between components, and resistance to separation, thereby enhancing the convenience of the system using this drill-free installation mechanism during operation.

The present invention also provides an example of a system using the drill-free installation mechanism, specifically a curtain, as shown in FIGS. 1 to 11, which includes a drill-free installation mechanism as described above. Specifically, the curtain includes the drill-free installation mechanism 3, a curtain body, and a fixing assembly 4. The curtain body includes curtain fabric 1. The fixing assembly 4 includes a deformable member 41 connected to the bottom end of the curtain fabric 1. When the curtain fabric 1 is rolled to a preset position, both ends of the deformable member 41 are fixedly connected to form a closed-loop structure, which maintains the posture of the curtain fabric 1. More specifically, the curtain body further includes a beam assembly 2 connected to the curtain fabric 1, and an installation mechanism 3 connected to the beam assembly 2. The installation mechanism 3 is arranged at both ends of the beam assembly 2 and fixed beneath it by screws. The support base 31 serves as a bracket fixedly mounted at one end of the upper beam assembly 2. The overall structure formed by the first and second plates of the support base 31 is L-shaped. The connection portion 314 is a mounting hole structure, with multiple such mounting holes arranged on the first plate. The support base 31 can be fixed to the upper beam assembly 2 by screws through the mounting holes.

In one specific embodiment of the present invention, and with reference to FIGS. 1 to 11, the deformable member 41 includes a first deformable body 411 and a second deformable body 412. The first deformable body 411 is connected to the bottom end of the curtain fabric 1, and a first connection end of the first deformable body 411 extends along one side of the curtain fabric 1. The second deformable body 412 is also connected to the bottom end of the curtain fabric 1, and a second connection end of the second deformable body 412 extends along the other side of the curtain fabric 1. When the curtain fabric 1 is rolled up, the first deformable body 411 and the second deformable body 412 move upward along the rolling center of the curtain fabric 1. After the curtain fabric 1 reaches a preset rolling height, the first and second connection ends are folded back around the edges of the curtain fabric from either side and are connected together to form a closed-loop structure. In this embodiment, the first and second connection ends can be fixedly connected by tying. That is, both the first and second connection ends have a strap-like structure. When a closed-loop structure needs to be formed, the first and second connection ends are tied together to form a slipknot structure. When the curtain fabric 1 needs to be unfolded, this slipknot structure can simply be released.

In any feasible embodiment, the fixing assembly 4 further includes a fixing member 42 connected to the deformable member 41. The fixing member 42 connects and secures both ends of the deformable member 41 through one or more of the following methods: adhesion, magnetic attachment, insertion, or snap-fit connection.

In this embodiment, the fixing member 42 comprises one or more of the following: hook-and-loop fasteners, connection buckles, magnetic clasps, or buttons.

In any feasible embodiment, the deformable member 41 is a flexible component. The deformable member 41 is fixed in a transverse orientation to the bottom end of the curtain fabric 1. Specifically, the first deformable body 411 is fixed to the bottom of the curtain fabric 1 and is a flexible component. One end of the first deformable body 411 extends transversely toward one side of the curtain fabric 1. The extension length of the first deformable body 411 is greater than half the width of the curtain fabric 1. As the curtain fabric 1 rolls upward, the first deformable body 411 moves upward with the rolling center of the curtain fabric 1. After reaching the desired rolled height, the extended end of the first deformable body 411 can fold back around the edge of the curtain fabric 1 from one side and connect with the second deformable body 412. The first deformable body 411 is connected to the second deformable body 412 by the fixing member 42, forming a closed loop with the curtain fabric 1, thereby securing the curtain fabric 1. The second deformable body 412 is fixed to the bottom of the curtain fabric 1 and is also a flexible component. One end of the second deformable body 412 extends in the opposite direction to the extension end of the first deformable body 411. As the curtain fabric 1 rolls upward, the second deformable body 412 moves upward with the rolling center of the curtain fabric 1. After reaching the desired rolled height, the extended end of the second deformable body 412 can fold back around the edge of the curtain fabric 1 from one side and connect to the first deformable body 411 through the fixing member 42, thereby forming a closed loop that secures the rolled portion of the curtain fabric 1. The function of the fixing member 42 is to connect the first deformable body 411 and the second deformable body 412 when needed. The fixing member 42 may be mounted directly on the first deformable body 411 and the second deformable body 412, or it may be an independent component.

Example 1: The first deformable body 411 is a flexible webbing, which is transversely fixed below the curtain fabric 1 by means such as adhesive or rivets. One end of the first deformable body 411 extends transversely outward toward one side of the curtain fabric 1. When the curtain fabric 1 is rolled upward, the first deformable body 411 moves upward along with the rolling center of the curtain fabric. Once it reaches the desired position, its extended end folds back around the side edge of the curtain fabric 1 and connects with the second deformable body 412 on the opposite side via the fixing member 42, thereby securing the curtain fabric 1 in the rolled position. The second deformable body 412 is also a flexible webbing, transversely fixed below the curtain fabric 1 by adhesive or rivets. One end of the second deformable body 412 extends in the direction opposite to the extended end of the first deformable body 411. Similarly, as the curtain fabric 1 is rolled upward, the second deformable body 412 moves upward with the rolling center of the curtain fabric 1. After reaching a certain height, its extended end folds back from the side of the curtain fabric opposite the extended end of the first deformable body 411 and connects with the first deformable body 411 on the other side through the fixing member 42, thus securing the curtain fabric 1. The fixing member 42 is a hook-and-loop fastener, consisting of a hook part and a loop part. One of them is arranged on one surface (front or back) of the first deformable body 411, while the corresponding part is arranged on the surface of the second deformable body 412 that faces the first deformable body 411. The first deformable body 411 and the second deformable body 412 can thus be connected and closed via the hook-and-loop fastener.

Example 2: Same as described in Example 1, the structure of the deformable member 41 is the same. Only the fixing member 42 differs, so other parts are not repeated here.

The fixing member 42 is a snap buckle composed of part a and part b. Part a and part b can snap together relative to each other. Multiple instances of part a and part b are evenly distributed on the first deformable body 411 and the second deformable body 412 respectively, arranged opposite each other. Part a and part b can freely pair and snap together to adjust the connection distance between the first deformable body 411 and the second deformable body 412. The snap buckle can more specifically be a magnetic buckle.

Example 3: Same as described in Example 1, the structure of the deformable member 41 is the same. Only the fixing member 42 differs, so other parts are not repeated here.

The fixing member 42 is a plug buckle, which consists of a plug and a socket. The plug and the socket are fixed respectively at the extended ends of the first deformable body 411 and the second deformable body 412. At least one fixed end of the plug or socket can adjust the distance relative to the first deformable body 411 and the second deformable body 412, thereby adjusting the connection distance between the first deformable body 411 and the second deformable body 412.

In any implementable embodiment, the first deformable body 411 and the second deformable body 412 are integrally formed. That is, the deformable member 41 is an elastic band structure. The first deformable body 411 and the second deformable body 412 are parts of the elastic band structure. Both ends of the elastic band structure are fixedly connected to both ends of the bottom of the curtain fabric 1.

It should be noted that the curtain fabric 1 and the beam assembly 2 belong to the prior art and are not the focus of the present case, so they will not be described in detail here for the sake of brevity.

The above descriptions are merely preferred embodiments of the present invention and are not intended to limit the scope of the present invention. Any modifications, equivalent substitutions, or improvements made within the spirit and principle of the present invention shall fall within the scope of protection of the present invention.

1. A drill-free installation mechanism comprising:
a support base configured to connect with an external structure;
a support block slidably connected to the support base;
an anti-slip structure arranged on the support block;
a status adjusting element movably connected to the support block, wherein when subjected to an acting force, the status adjusting element drives the support block to move relative to the support base and limits the connection posture between the support block and the support base.

2. The drill-free installation mechanism according to claim 1, wherein:
the support base is provided with a positioning groove for limiting the relative movement direction between the support block and the support base; the support is provided with a sliding block adapted to the positioning groove.

3. The drill-free installation mechanism according to claim 2, wherein:
the support base comprises:
a first plate, one end of which is provided with the positioning groove;
a second plate arranged at an angle to the first plate, the second plate being provided with a slotted hole for positioning the status adjusting element.

4. The drill-free installation mechanism according to claim 3, wherein:
the support block comprises:
a support block body provided with the sliding block;
a connecting rod connected to the support block body, one end of the connecting rod passing through the second plate as a connection end; the connection end being connected to the status adjusting element.

5. The drill-free installation mechanism according to claim 3, wherein:
one end face of the support block body is fixedly connected to the connecting rod; the other end face is provided with a receiving groove adapted to the anti-slip structure.

6. The drill-free installation mechanism according to claim 1, wherein:
the connecting rod is connected to the status adjusting element by one or more of threaded connection, snap connection, or plug connection.

7. The drill-free installation mechanism according to claim 3, wherein:
the first plate is provided with a connection portion configured to connect with an external structure.

8. A system, wherein it comprises a drill-free installation mechanism according to claim 1.

9. A system, wherein it comprises a drill-free installation mechanism according to claim 2.

10. A system, wherein it comprises a drill-free installation mechanism according to claim 3.

11. A system, wherein it comprises a drill-free installation mechanism according to claim 4.

12. A system, wherein it comprises a drill-free installation mechanism according to claim 5.

13. A system, wherein it comprises a drill-free installation mechanism according to claim 6.

14. A system, wherein it comprises a drill-free installation mechanism according to claim 7.
